(19) United States
(12) Patent Application Publication
(10) Pub. No.: US 2004/0156961 A1
(43) Pub. Date: Aug. 12, 2004

(54) Method and device for storing natural casings and deep-frozen natural casings

(76) Inventor: Oliver Woiwode, Bornheim-Merten (DE)

Correspondence Address: Brown Raysman Millstein, Felder & Steiner, 163 Madison Avenue, PO Box 1989, Morristown, NJ, 07962-1989, US

(21) Appl. No.: 10/432,912

(22) PCT Filed: Nov. 30, 2001
(86) PCT No.: PCT/EP01/14003

(30) Foreign Application Priority Data
Dec. 2, 2000 (DE) 100 59 989.3

(51) Int. Cl. A23K 1/00

(52) U.S. Cl. 426/327

(57) ABSTRACT

The invention relates to a method for storing natural casings, especially hog casings and sheep casings, for packaging meat and sausages, according to which the natural casings are deep-frozen to at least −50° C. after processing. The invention also relates to deep-frozen casings and to a device for holding natural casings that are placed on rod-shaped support devices. Said device comprises two supports (14) and, interlinked therewith, a plurality of insertion elements (16, 18) into which receiving devices (20) are inserted. Every receiving device (20) has holding elements (22) onto which the rod-shaped support devices (24) are placed. The gathered natural casings are disposed on the support devices (24). The frame that is loaded with natural casings (26) is then transported to a cooling or freezing installation for deep-freezing the natural casings.

The present invention relates to a method and a device for storing natural casings and deep-frozen casings.

Meat products, in particular sausages, are filled into natural casings. The natural casings used are taken in particular form pigs and sheep. The casings are removed from the butchered animals and processed for being used as meat packaging or sausage sheaths. This processing substantially comprises the cleaning thereof.

Typically, the natural casings are stored in a brine for preservation until they are used. Depending on the concentration of the brine, the natural casings may possibly be preserved for several weeks. The brine draws water from the natural casing so that the sliding properties of the casing are reduced. Therefore, prior to being filled, the natural casings are soaked to remove most of the brine and to improve the sliding properties in particular of the inner side of the casing for the filling process. For long storage times, for which the concentration of the salt in the brine has to be increased, the process of soaking before filling the casings is extended and the sliding properties decrease further. Thus, the percentage of ruptured casings in the filling process increases. After soaking, the natural casings are storable/preserved for only about 4 days.

It is known from DE 1812370 to deep-freeze natural casings such as pig and sheep casings in a range from −35 to −55° C. for preservation and storage. To this end, the casings are arranged in a pressure chamber subsequently filled with nitrogen and placed into a suitable cold room. Here, the casings may freeze to each other in the chamber.

From DE 6910556, a device for drying and for cutting casings is known that comprises rod-shaped support means onto which the casings may be slipped.

It is desirable to achieve a longer storage period of natural casings and less effort in preparing the filling of the natural casings.

The technical problem the invention is based on is to provide a method and a device wherein a freezing of the natural casings to each other is avoided.

The object is solved according to the invention with claims 1 and 7, respectively.

This problem is solved with a method for storing natural casings, in particular casings of pigs and sheep for packing meat and sausages, wherein, after preparation, the natural casings are slipped onto substantially rod-shaped support means and are subsequently deep-frozen to at least −50° C. Preferably, the casings are deep-frozen to at least −60° C., more preferably to at least −70° C.

By providing single natural casings on separate substantially rod-shaped support means, the natural casings can be prevented from freezing to each other and, thus, damages to the casings while thawing are avoided. Therefore, the support means are preferably mounted to a frame, the distance between the support means being chosen such that the natural casings slipped onto the support means do not contact each other. Most preferably, the support means are removably attached to the frame. Thus, it is possible to slip the natural casings, preferably mechanically, onto the substantially rod-shaped support means and to subsequently connect the individual support means with the frame. The present method thus preferably comprises the additional step of removably mounting the support means provided with natural casings to a frame. This is further advantageous in that after deep-freezing, the natural casings may be removed from the frame together with the support means and may also be transported together with the support means.

Preferably, the freezing process is controlled such that the natural casings are deep-frozen very quickly to the temperature of at least −30° C.

Subsequent further cooling may occur slower. This may be achieved e.g. by efficient cooling installations. These are capable of dissipating large amounts of heat in relatively little time. For the practice of the invention, commercially available cooling installations of Linde AG, Germany, are contemplated in particular. Preferably, the shock-freezing and, possibly, the entire freezing is done in a nitrogen environment or with addition of nitrogen.

Preferably, the entire deep-freezing is done in less than 15 minutes, in particular in less than 10 minutes, and most preferably, in less than 7 minutes.

Shock-freezing the natural casings according to the present invention allows for months of storage time, with the properties of the natural casings being substantially preserved. Microbic contamination is reduced to a minimum.

The present method further has a positive effect on the preservation of the water content in the natural casing, which in turn causes an improved further processing in the meat product industry. In the usual preservation using salt, water is drawn from the casing and the further processing requires more effort. The present method preserves the sliding properties of the natural casing after storing and thawing. It is another advantage, that a clean handling and a correspondingly hygienic shipping is possible. The brine otherwise used in storing or preserving may leak during transport or handling of the natural casings, causing not only soiling in the filling companies and the transport vehicles but also a drying of the natural casings, so that they can no longer be used.

Thawing the natural casings deep-frozen according to the invention may be effected within about 10 minutes so that the natural casings ready for filling within 10 minutes. The natural casings are preferably thawed in warm water that may possibly be mixed with suitable additives. Since a fast thawing of the natural casings deep-frozen according to the invention is possible without affecting the quality of the natural casings, variations in demand can be compensated quickly. With respect to conventional natural casings stored in brine, this is advantageous in that the natural casings can be provided much faster for further processing. With natural casings stored in brine, it is necessary to soak them already the day before to substantially remove the brine and to make especially the inner side of the natural casing more sliding for the filling. With shorter soaking times, the brine is not removed sufficiently from the natural casing so that the percentage of burst natural casings increases during filling. The present method further offers the advantage that no brines are needed and thus, the disposal of brines is avoided. Accordingly, the present method is more environmentally compatible.

Preferably, the preparation comprises desalting and soaking the natural casings, possibly with the help of softeners approved for contact with food.

Moreover, the invention refers to a device for holding natural casings slipped onto rod-shaped support means. Here, prior to freezing, the natural casings are mechanically slipped onto rod-shaped support means such as plastics tubes, so that the natural casing is provided on the support means in a gathered manner. Subsequently, the support means with the natural casing thereon is releasably attached to a movable frame. The movable frame can then be moved into a cooling or freezing installation for freezing the natural casings.

The device for holding natural casings that can be slipped onto rod-shaped support means thus comprises a movable frame to which the support means are releasably mounted. Preferably, a plurality of support means is provided so that a large amount of natural casings can be accommodated on one frame and frozen together. The present device allows for an economic freezing of a large amount of natural casings so as to provide for long-term storage and a facilitated processing of the natural casings.

Preferably, the support means are retained such at the frame that contact with the natural casings slipped onto the support means is avoided during freezing. Thus, a tearing or damaging of the natural casings during subsequent processing is avoided.

For an easy handling of the support means, the frame comprises receiving means with at least one holding element. The holding element serves to hold the support means, the holding elements being designed such that the support means may be connected to the holding element through an insertion element. The holding elements preferably are rod-shaped projections with an outer diameter corresponding to the inner diameter of support means designed as tubes. This allows for a simple plugging of the support means on the holding elements.

The holding elements are preferably designed such that the support means are arranged slanting upward from the holding elements. This is advantageous in that the natural casings can not slip from the support means when on the movable frame. Therefore, the natural casings need not be specially secured against slipping off.

The individual holding elements provided on the frame are arranged at a distance sized such that contact between the natural casings is avoided. This avoids damage to the natural casings during freezing and subsequent processing. The receiving means of the frame preferably has at least five, more preferred at least seven, and in particular at least nine holding elements. Preferably, the number of support means provided at a receiving means is chosen such that an entire batch of natural casings can be accommodated per receiving means. A batch is a common unit of 91.4 m in length. Thus, the length of the individual natural casings slipped on support means inserted into one receiving means sums up to 91.4 m.

In a particularly preferred embodiment the receiving means are also connected to the frame through insertion elements. Thus, it is possible to load a receiving means having a plurality of holding elements with a number of support means, independent from the frame. The receiving means provided with support means is then connected to the frame through the insertion element. Preferably, the insertion elements are bushings into which the receiving elements may be inserted. Preferably, the frame has a plurality of receiving means. The number of receiving means is selected such that increased loss of humidity of the natural casings is avoided during the loading of the frame.

Preferably, the natural casing is soaked while on the support means, possibly in the presence of softeners, and moved to transportable frames after soaking.

As soon as a frame is fully loaded or a maximum period for loading the frame has passed, the movable frame is pushed into a corresponding cooling or freezing installation for deep-freezing. There, the natural casings are deep-frozen at −70° C. for 7-10 minutes, preferably. Preferably, deep-freezing occurs in a nitrogen environment or with addition of nitrogen.

After shock-freezing, the deep-frozen natural casings on the tubes or support means are removed from the freezer and packed. Further storing and transport are done in deep-frozen state, preferably at a temperature of −5 to −10° C. The user can store the natural casings for several months in the deep-frozen state without the natural casings becoming unsuitable for use as sausage sheaths.

Besides longer storage time, using deep-frozen natural casings is advantageous in that the process cycles of processing the casings can be reduced significantly since the natural casings can be thawed and processed further within a few minutes, preferably less than 10 minutes. This has the further advantage that also short-term variations in demand can be compensated quickly. To achieve such quality with natural casings stored in brine, they would have to be soaked already the day before. If natural casings are soaked only for a short time, the brine will not be removed sufficiently from the natural casing so that the natural casing is more prone to tear while being filled. This increases the production costs and the consumption of natural casings and fillings such as meat and sausages. It is another advantage that the transport costs for frozen natural casings are much lower since the natural casings need not be transported in brine and the shipping weight is substantially lower, therefore.

The present invention also refers to a deep-frozen natural casing slipped onto a rod-shaped support means, in particular a substantially cylindrical support means. The deep-frozen natural casing is obtained by a shock-freezing method according to the invention.

The present natural casing is preferably suitable for industrial processing, since a rational processing with low preparation effort is provided.

### EXAMPLE

Hog casings for filling with sausage are desalted and soaked using an aqueous solution containing a softening agent. The casings thus treated are slipped onto tubes and simultaneously rinsed on the inside with the aqueous solution. The slipped-on casings are put into the above solution.

The individual tubes are then placed on or stuck to a movable frame. The tubes with the casings should not touch each other and should be applied as fast as possible to preserve the water content in the casing. Then, the carriage is moved into a shock-freezer where shock-freezing to about −50° C. to −80° C., preferably −65° C. to −75° C., occurs under addition of nitrogen.

Thereafter, the casings can be removed and bundled to obtain the conventional unit of a bunch, i.e. 91.4 m. the casings are packed in cardboard boxes with inlaying bags that preferably contain one, three or five bunches. Storing and shipping are effected in the deep-frozen state.

The following is a detailed description of a preferred embodiment of the invention with reference to the accompanying drawings.

In the Figures:

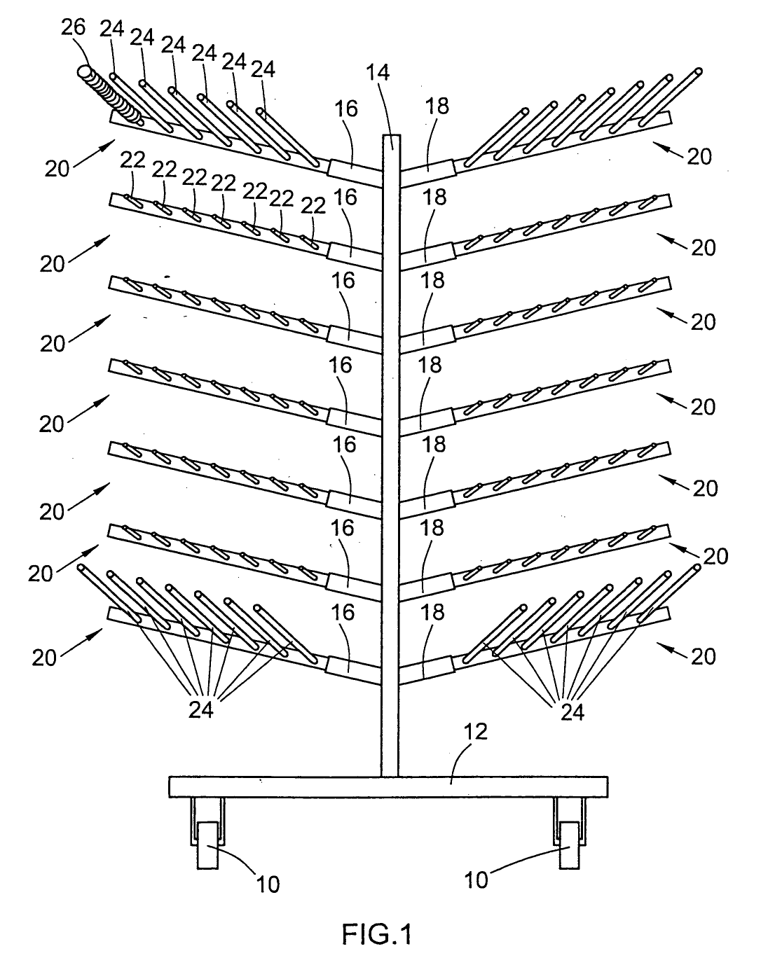

FIG. 1 is a schematic side elevational view of an embodiment of the device according to the present invention, and

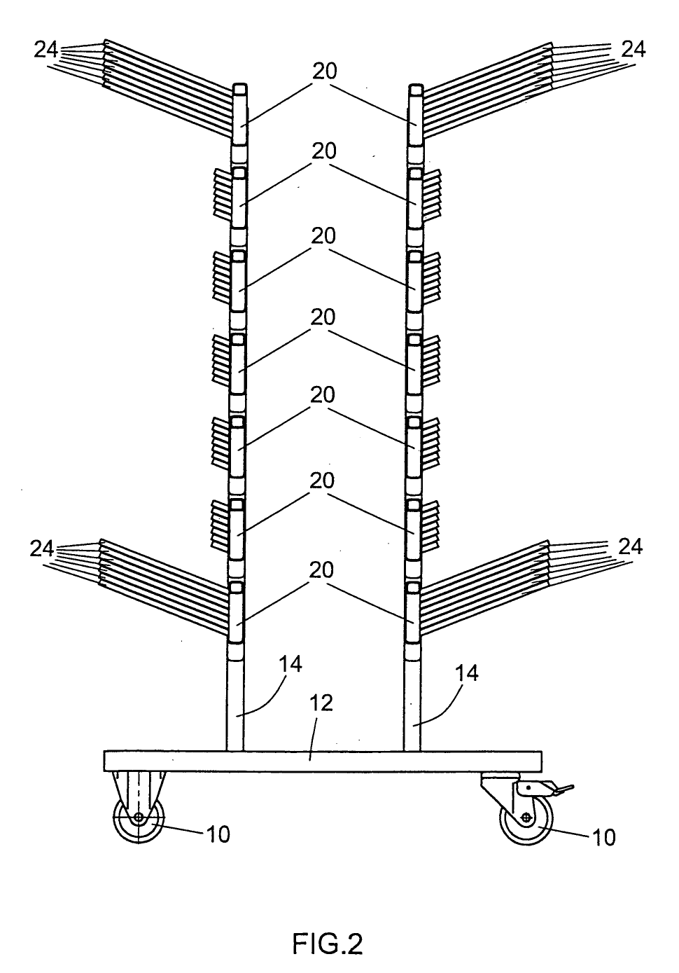

FIG. 2 is a schematic front view of the embodiment of FIG. 1.

On a base plate 12 with rollers 10, the embodiment of the frame illustrated in FIGS. 1 and 2 comprises two supports 14, arranged one behind the other in FIG. 1. Each support 14 is provided with a plurality of insertion elements 16, 18. The insertion elements 16 are arranged one above the other at a substantially constant spacing. Opposite each insertion element 16, a respective insertion element 18 is provided so that pairs of mutually opposite insertion elements 16, 18 are formed.

Inserted in each insertion element 16, 18 is a receiving means 20. The receiving means 20 have a round cross section in the embodiment illustrated. In order to avoid twisting of the receiving means 20 in the insertion elements 16, 18, the receiving means 20 and/or the insertion elements 16, 18 comprise an anti-twist means. This may e.g. be designed such that the insertion elements 16, 18 have a non-round cross section and the receiving means 20 have corresponding complementary cross section that is also non-round.

Each individual receiving means comprises a plurality of holding elements 22 in the form of rod-shaped pins. The support means 24 are stuck onto the holding elements 22.

For the sakes of clarity, FIGS. 1 and 2 illustrate support means 24 only on the lower and upper receiving means 20, respectively. A gathered natural casing 26 is represented on one support means 24. When the frame is fully loaded, of course all support means 24 are provided with natural casings 26. Similarly, all receiving means 20 are provided with support means 24.

The holding elements 22 provided at the receiving means 20 are arranged obliquely so that the support means 24 are slanted upwards, as far as the receiving means 20 are inserted into the insertion elements 16, 18. Thus, the natural casings 26 are kept from slipping off.

The individual support means 24 are loaded with natural casings by a machine, the natural casings subsequently being present on the support means 24 in gathered form. Afterwards, the support means 24 loaded with natural casing is manually or automatically set on a holding element 22. Here, it is not necessary for the receiving means to already be inserted in an insertion element 16, 18 of the frame. The receiving means 20 may also be held in a holder provided adjacent the machine.

Thereafter, the next support means is loaded with natural casing and also set onto the receiving means 20. When all holding elements 22 of the receiving means 20 are loaded with support means 24, the entire receiving means 20 is fastened to the frame by being inserted into an insertion means 16, 18.

Then, the next receiving means 20 is loaded with support means 24 on which the natural casing is provided.

Due to the arrangement of the individual receiving means 20 and the supports 14, one frame can be loaded by two or up to four people at the same time. This reduces the time the natural casings are on the frame before freezing. As soon as a frame is fully loaded with natural casings, the frame is moved into a cooling or freezing installation. This may be done by simply pushing the frames if the same are provided with rollers 10. The frames may also be moved automatically.

1. Method for storing natural casings, in particular casings of hogs and sheep, for packaging meat and sausages, the natural casings (26) being deep-frozen after preparation and the natural casings (26) are slipped onto substantially rod-shaped support means (24) before deep-freezing
characterized in that
the natural casings (26) are shock-frozen before deep-freezing.

2. The method of claim 1, wherein the support means (24) loaded with natural casings (26) are removably attached to a frame.

3. The method of claim 1 or 2, wherein the natural casings (26) are shock-frozen to a temperature of at least −30° C. before deep-freezing.

4. The method of one of claims 1-3, wherein the natural casings (26) are shock-frozen to a temperature of at least −50° C. before deep-freezing.

5. The method of one of claims 1-4, wherein the preparation includes desalting the natural casings and soaking the natural casings.

6. The method of one of claims 1-5, wherein the preparation is performed using softening agents approved for contact with food.

7. Device for holding natural casings (26) slipped on rod-shaped support means (24), comprising a movable frame for transport into a freezing installation, the support means (24) being removably attached to the frame.

8. The device of claim 7, characterized in that the frame comprises receiving means (20) with at least one holding element (22) for holding the support means (24) through an insertion coupling.

9. The device of claim 8, characterized in that the holding elements (22) are designed such that the support means (24) are slanted upward from the holding elements (22).

10. The device of claim 8 or 9, characterized in that the holding elements (22) are arranged with a mutual spacing that avoids contact between the natural casings (26).

11. The device of one of claims 8-10, characterized in that each receiving means (20) comprises at least five holding elements (22).

12. The device of one of claims 7-11, characterized in that, for receiving the receiving means (20), the frame comprises insertion elements (16, 18) for inserting the receiving means (20).

13. The device of claim 12, characterized in that the insertion elements are designed as bushings.

14. The device of claim 12 or 13, characterized in that the frame comprises a support (14) carrying the insertion elements (16, 18).

15. The device of claim 14, characterized in that the insertion elements (16, 18) are arranged one above the other on the support (14).

16. The device of one of claims 12-14, characterized in that two respective insertion elements (16, 18) are arranged opposite each other on the support (14).

17. The device of claim 14 or 15, characterized in that the frame comprises at least two mutually spaced, substantially vertical supports (14).

18. The device of one of claims 7-17, characterized in that the frame has rollers (10) for moving the device.

19. Use of the device of one of claims 7-18 for holding the natural casings (26) in a freezing unit.
